(19) United States
(12) Patent Application Publication
(10) Pub. No.: US 2015/0004402 A1
(43) Pub. Date: Jan. 1, 2015

(54) INTUMESCENT COATING COMPOSITION COMPRISING PARTICULATE POLY(PHENYLENE ETHER)

(71) Applicant: SABIC Innovative Plastics IP B.V., Bergen op Zoom (NL)

(72) Inventors: EYLEM TARKIN-TAS, DELMAR, NY (US); EDWARD NORMAN PETERS, LENOX, MA (US)

(21) Appl. No.: 13/930,456

(22) Filed: Jun. 28, 2013

(51) Int. Cl. C09D 5/18

(52) U.S. Cl. CPC C09D 5/185
USPC 428/339; 521/135; 521/92; 521/91; 521/89; 521/85; 427/386; 428/457

(57) ABSTRACT

An intumescent coating composition having improved char yield, while maintaining its physical, mechanical, and esthetic properties comprises (a) particulate poly(phenylene ether), wherein the mean particle size of the poly(phenylene ether) is 1 to 100 micrometers; (b) a film-forming binder; (c) an acid source; (d) a blowing agent; and (e) optionally, a carbon source other than the particulate poly(phenylene ether); wherein polyolefins, homopolystyrenes, rubber-modified polystyrenes, styrene-containing copolymers, and hydrogenated and unhydrogenated block copolymers of an alkenyl aromatic compound and a conjugated diene are all absent from the composition. A method of forming the intumescent coating composition comprises: mixing the particulate poly(phenylene ether), the film-forming binder, the acid source, and the blowing agent, wherein the particulate poly(phenylene ether) has a glass transition temperature, and wherein the mixing is carried out at a temperature below the glass transition temperature of the particulate poly(phenylene ether).

### BACKGROUND OF THE INVENTION

Intumescent coating compositions are used to protect components of buildings, including walls and structural steel components against fire. In addition to a film-forming binder, intumescent coating compositions contain ingredients that under the influence of heat, react together to produce an insulating foam or “char”, which has a volume many times that of the original coating, and low thermal conductivity. This char reduces the rate of heating experienced by the substrate, thus extending the time before the substrate begins to burn and/or collapse. In the case of structural steel, the char increases the time before the steel loses its integrity and the building/structure collapses. Thus an intumescent coating provides additional time for safe evacuation from a building in the event of a fire.

An intumescent coating composition comprises, in addition to a film-forming binder, a carbon source, an acid source, and a blowing agent. The carbon source can be a polyhydric alcohol, for example erythritol or pentaerythritol. The acid source releases a strong acid catalyst when exposed to the heat of a fire. For example, when the acid catalyst is ammonium polyphosphate, phosphoric acid is generated, which reacts with the polyhydric alcohol to release ammonia and phosphate esters, which decompose to a carbon char, phosphoric acid, water, and carbon dioxide. The blowing agent releases gases causing further expansion of the carbon char and formation of a cellular structure. For example, when the blowing agent is melamine, ammonia gas is released, which also serves to dilute the oxygen at the char surface.

Although carbon sources such as erythritol or pentaerythritol have been used in intumescent coating compositions, there is room for improvement in char yield. Thus, there remains a need for a carbon source which provides a higher amount of char in a fire, and which does not adversely affect the physical, mechanical, and esthetic properties of the coating film.

### BRIEF SUMMARY OF EMBODIMENTS OF THE INVENTION

The need for an intumescent coating composition having improved char yield, while maintaining its physical, mechanical, and esthetic properties, is met by an intumescent coating composition comprising: (a) particulate poly(phenylene ether), wherein the mean particle size of the poly(phenylene ether) is 1 to 100 micrometers; (b) a film-forming binder; (c) an acid source; (d) a blowing agent; and (e) optionally, a carbon source other than the particulate poly(phenylene ether); wherein polyolefins, homopolystyrenes, rubber-modified polystyrenes, styrene-containing copolymers, and hydrogenated and unhydrogenated block copolymers of an alkenyl aromatic compound and a conjugated diene are all absent from the composition.

A method of forming the intumescent coating composition comprises: mixing the particulate poly(phenylene ether), the film-forming binder, the acid source, and the blowing agent, wherein the particulate poly(phenylene ether) has a glass transition temperature, and wherein the mixing is carried out at a temperature below the glass transition temperature of the particulate poly(phenylene ether).

Other embodiments include a coating film derived from the intumescent coating composition, comprising: a) a continuous phase comprising the film-forming binder or a cured product of the film-forming binder; and b) a disperse phase comprising the particulate poly(phenylene ether), wherein the particulate poly(phenylene ether) has a mean particle size of 1 to 40 micrometers; a coated article comprising the coating film adhered to the article; and a method of protecting an article against fire, comprising applying the intumescent coating composition to at least one surface of the article, and drying or curing the composition to form a coating film.

### BRIEF DESCRIPTION OF THE DRAWINGS

Referring now to the drawings:

FIG. 1 is a flow chart for the preparation of the intumescent coating composition of Ex. 1, comprising an epoxy resin as the film-forming binder.

FIG. 2 depicts samples of the compositions of Comp. Ex. 1, Ex. 1a, and Ex. 1b before (FIG. 2a) and after (FIGS. 2b and 2c) heating at 500° C. in a muffle furnace.

### DETAILED DESCRIPTION OF THE INVENTION

Polymer degradation and combustion are complex chemical processes. Mechanistic studies have shown that combustion and fire resistance in polymers are closely related to their degradation behavior. C. F. Cullis, M. M. Hirschler, The Combustion of Organic Polymers, Clarendon Press, Oxford 1981. In the two-stage combustion model, two consecutive chemical processes take place in a fire—decomposition and combustion. When a polymer is heated to temperatures above its decomposition temperature, the polymer undergoes pyrolysis, which produces volatile low-molecular weight compounds. These compounds undergo combustion in the vapor (gas) phase, generating heat. The heat of combustion supports decomposition of more polymer. In addition to combustible vapors that are produced during pyrolysis, some polymers form a carbonaceous pyrolysis residue in the condensed (solid) phase. This carbonaceous residue is referred to as “char”. Poly(phenylene ether) tends to form char, and therefore generates smaller amounts of combustible gases on an equal weight basis than polymers that do not produce char. Moreover, the char can form a thermal barrier between the substrate and the flame. Increased char yield can reduce the generation of combustible gases, limit the heat emitted by pyrolysis reactions, decrease heat conductivity of the substrate, and thus reduce overall flammability.

The present inventors have prepared intumescent coating compositions comprising particulate poly(phenylene ether) that have increased char yield. The particulate poly(phenylene ether) advantageously increases the char yield of the coating compositions. Increased char yield means that less volatile fuel is being produced by thermal degradation, and the char, while intact and in place, reduces heat transfer to the substrate. Advantageously, the particulate poly(phenylene ether) does not adversely affect the strength, toughness, integrity, and appearance, of the coating film. Moreover, the particulate poly(phenylene ether) can provide improved dielectric properties and an improved moisture barrier.

As used herein, “solvent” can be an organic solvent, water, or a combination thereof.

As used herein, “dry weight of the composition” refers to the total solids content of the intumescent coating composition, i.e. the weight of the composition less solvent.

All ranges disclosed herein are inclusive of the endpoints, and the endpoints are independently combinable with each other. The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first”, “second”, “(a)”, “(b)”, and the like herein do not denote any order, quantity, or importance, but rather are used to distinguish one element from another. All component weight percents are expressed on a solids basis, i.e. any solvent is not included in the weight of the component.

The intumescent coating composition comprises: (a) particulate poly(phenylene ether), wherein the mean particle size of the poly(phenylene ether) is 1 to 100 micrometers; (b) a film-forming binder; (c) an acid source; and (d) a blowing agent; and (e) optionally, a carbon source other than the particulate poly(phenylene ether); wherein polyolefins, homopolystyrenes, rubber-modified polystyrenes, styrene-containing copolymers, hydrogenated and unhydrogenated block copolymers of an alkenyl aromatic compound and a conjugated diene are all absent from the composition. In some embodiments, the intumescent coating composition comprises: (a) 1 to 40 weight percent of the poly(phenylene ether); (b) 50 to 90 weight percent of the film-forming binder; (c) 4 to 60 weight percent of the acid source; (d) 1 to 30 weight percent of the blowing agent; and (e) 0 to 40 weight percent of the carbon source other than the particulate poly(phenylene ether); wherein all weight percents are based on the total weight of the poly(phenylene ether), the film-forming binder, the acid source, the blowing agent, and the carbon source other than the particulate poly(phenylene ether.

The intumescent composition comprises particulate poly(phenylene ether), wherein the mean particle size of the poly(phenylene ether) is 1 to 100 micrometers. Advantageously, the particulate poly(phenylene ether) is an effective carbon source. A carbon source is defined as an organic material that decomposes to a char consisting primarily of carbon when exposed to fire or heat. In the presence of an acid source, which promotes the formation of the char, and a blowing agent, which expands the char, the carbon source can generate an expanded, insulating, cellular structure that can be several times thicker than the original coating film, when exposed to fire or heat.

The poly(phenylene ether) comprises repeating structural units of the formula

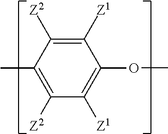

wherein for each structural unit, each Z¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each Z² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as “substituted”, it can contain heteroatoms over and above the carbon and hydrogen members of the substituent residue. Thus, when specifically described as substituted, the hydrocarbyl residue can also contain halogen atoms, nitro groups, cyano groups, carbonyl groups, carboxylic acid groups, ester groups, amino groups, amide groups, sulfonyl groups, sulfoxyl groups, sulfonamide groups, sulfamoyl groups, hydroxyl groups, alkoxyl groups, or the like, and it can contain heteroatoms within the backbone of the hydrocarbyl residue.

The poly(phenylene ether) can comprise molecules having aminoalkyl-containing end group(s), generally located ortho to the hydroxy group. Also frequently present are tetramethyldiphenoquinone (TMDQ), tetramethylbiphenyl (TMBP), or diphenoquinone residue end groups, generally obtained from reaction mixtures in which tetramethyldiphenoquinone by-product is present. In some embodiments the poly(phenylene ether) comprises TMDQ end groups in an amount of less than 5 weight percent, specifically less than 3 weight percent, more specifically less than 1 weight percent, based on the weight of the poly(phenylene ether). In some embodiments, the poly(phenylene ether) comprises, on average, about 0.7 to about 2 moles, specifically about 1 to about 1.5 moles, of chain-terminal hydroxyl groups per mole of poly(phenylene ether).

The poly(phenylene ether) can be in the form of a homopolymer, a copolymer, a graft copolymer, an ionomer, or a block copolymer, as well as a combination comprising at least one of the foregoing. Poly(phenylene ether) includes polyphenylene ether comprising 2,6-dimethyl-1,4-phenylene ether units optionally in combination with 2,3,6-trimethyl-1,4-phenylene ether units. In some embodiments, the poly(phenylene ether) is an unfunctionalized poly(phenylene ether). An unfunctionalized poly(phenylene ether) is a poly(phenylene ether) consisting of the polymerization product of one or more phenols. The term “unfunctionalized poly(phenylene ether)” excludes functionalized poly(phenylene ether)s such as acid-functionalized poly(phenylene ether)s and anhydride-functionalized poly(phenylene ether)s. In some embodiments, the poly(phenylene ether) comprises poly(2,6-dimethyl-1,4-phenylene ether).

The poly(phenylene ether) can be prepared by the oxidative coupling of monohydroxyaromatic compound(s) such as 2,6-xylenol and/or 2,3,6-trimethylphenol. Catalyst systems are generally employed for such coupling. They can contain heavy metal compounds such as copper, manganese, or cobalt compounds, usually in combination with one or more ligands such as a primary amine, a secondary amine, a tertiary amine, a halide, or a combination of two or more of the foregoing.

In some embodiments, the composition comprises less than or equal to 2 weight percent, specifically less than or equal to 1 weight percent, more specifically less than or equal to 0.5 weight percent, of a poly(phenylene ether)-polysiloxane block copolymer. In some embodiments, the composition excludes poly(phenylene ether)-polysiloxane block copolymer. Poly(phenylene ether)-polysiloxane block copolymers, which comprise at least one poly(phenylene ether) block and at least one polysiloxane block, are described, for example, in U.S. Patent Application Publication No. US 2010/0139944 A1 (Guo et al.).

In some embodiments, the poly(phenylene ether) is characterized by a weight average molecular weight and a peak molecular weight, wherein a ratio of the weight average molecular weight to the peak molecular weight is 1.3:1 to 4:1. Within this range, the ratio can be 1.5:1 to 3:1, specifically 1.5:1 to 2.5:1, more specifically 1.6:1 to 2.3:1, still more specifically 1.7:1 to 2.1:1. As used herein, the term “peak molecular weight” is defined as the most commonly occurring molecular weight in the molecular weight distribution. In statistical terms, the peak molecular weight is the mode of the molecular weight distribution. In practical terms, when the molecular weight is determined by a chromatographic method such as gel permeation chromatography, the peak molecular weight is the poly(phenylene ether) molecular weight of the highest point in a plot of molecular weight on the x-axis versus absorbance on the y-axis.

In some embodiments, the poly(phenylene ether) is essentially free of incorporated diphenoquinone residues. “Diphenoquinone residues” refers to the dimerized moiety that can form in the oxidative polymerization reaction giving rise to the poly(phenylene ethers) contemplated for use in the present invention. As described in U.S. Pat. No. 3,306,874 (Hay), synthesis of poly(phenylene ethers) by oxidative polymerization of monohydric phenols yields not only the desired poly(phenylene ether) but also a diphenoquinone side product. For example, when the monohydric phenol is 2,6-dimethylphenol, 3,3′,5,5′-tetramethyldiphenoquinone (TMDQ) is generated. In general, the diphenoquinone is “re-equilibrated” into the poly(phenylene ether) (i.e., the diphenoquinone is incorporated into the poly(phenylene ether) structure) by heating the polymerization reaction mixture to yield a poly(phenylene ether) comprising terminal or internal diphenoquinone residues. As used herein, “essentially free” means that fewer than 1 weight percent of poly(phenylene ether) molecules comprise the residue of a diphenoquinone as measured by nuclear magnetic resonance spectroscopy (NMR) (Mole of TMDQ×Molecular Weight of unit TMDQ)/(Mole of Polymer×Number Average Molecular Weight (Mₙ)). In some embodiments, fewer than 0.5 weight percent of poly(phenylene ether) molecules comprise the residue of a diphenoquinone.

For example, as shown in Scheme 1, when a poly(phenylene ether) is prepared by oxidative polymerization of 2,6-dimethylphenol to yield poly(2,6-dimethyl-1,4-phenylene ether) and 3,3′,5,5′-tetramethyldiphenoquinone, reequilibration of the reaction mixture can produce a poly(phenylene ether) with terminal and internal residues of incorporated diphenoquinone.

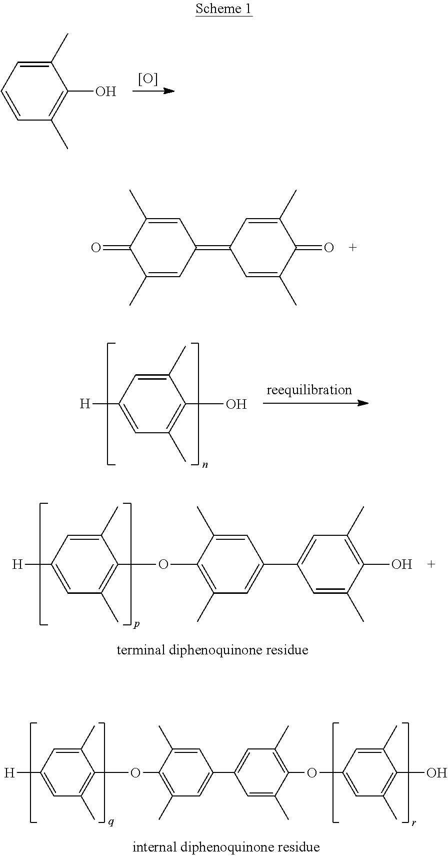

However, such re-equilibration reduces the molecular weight of the poly(phenylene ether) (e.g., p and q+r are less than n). Accordingly, when a higher molecular weight and stable molecular weight poly(phenylene ether) is desired, it may be desirable to separate the diphenoquinone from the poly(phenylene ether) rather than re-equilibrating the diphenoquinone into the poly(phenylene ether) chains. Such a separation can be achieved, for example, by precipitation of the poly(phenylene ether) in a solvent or solvent mixture in which the poly(phenylene ether) is insoluble and the diphenoquinone is soluble with very minimum time between end of reaction and precipitation.

For example, when a poly(phenylene ether) is prepared by oxidative polymerization of 2,6-dimethylphenol in toluene to yield a toluene solution comprising poly(2,6-dimethyl-1,4-phenylene ether) and 3,3′,5,5′-tetramethyldiphenoquinone, a poly(2,6-dimethyl-1,4-phenylene ether) essentially free of diphenoquinone can be obtained by mixing 1 volume of the toluene solution with about 1 to about 4 volumes of methanol or methanol water mixture. Alternatively, the amount of diphenoquinone side-product generated during oxidative polymerization can be minimized (e.g., by initiating oxidative polymerization in the presence of less than 10 weight percent of the monohydric phenol and adding at least 95 weight percent of the monohydric phenol over the course of at least 50 minutes), and/or the re-equilibration of the diphenoquinone into the poly(phenylene ether) chain can be minimized (e.g., by isolating the poly(phenylene ether) no more than 200 minutes after termination of oxidative polymerization). These approaches are described in International patent application Ser. No. 12/255,694, published as United States Published Application 2009/0211967 (Delsman et al.). Alternatively, diphenoquinone amounts can be achieved by removing the TMDQ formed during polymerization by filtration, specifically after stopping the oxygen feed into the polymerization reactor. In some embodiments, the poly(phenylene ether) comprises 2,6-dimethyl-1,4-phenylene ether units, 2,3,6-trimethyl-1,4-phenylene ether units, or a combination thereof. In some embodiments, the poly(phenylene ether) is a poly(2,6-dimethyl-1,4-phenylene ether).

In some embodiments, the poly(phenylene ether) comprises poly(2,6-dimethyl-1,4-phenylene ether), CAS Reg. No. 24938-67-8, having a glass transition temperature of 215° C., and an intrinsic viscosity of 0.3 to 1.5 deciliter per gram, specifically 0.3 to 0.6 deciliters per gram, as measured in chloroform at 25° C. For poly(2,6-dimethyl-1,4-phenylene ether), an intrinsic viscosity of 0.3 to 0.6 deciliters per gram corresponds to a number average molecular weight range of 16,000 to 25,000 atomic mass units. In specific embodiments, the poly(phenylene ether) comprises poly(2,6-dimethyl-1,4-phenylene ether) having an intrinsic viscosity of 0.46 deciliters per gram, 0.40 deciliters per gram, or 0.30 deciliters per gram.

The particulate poly(phenylene ether) has a mean particle size (volume distribution) of 0.01 to 100 micrometers, as determined by particle size distribution analysis. Within this range, the particulate poly(phenylene ether) can have a mean particle size of 1 to 100 micrometers, specifically 1 to 40 micrometers, more specifically 1 to 20 micrometers, and still more specifically 1 to 10 micrometers. In some embodiments, the particulate poly(phenylene ether) has a mean particle size of 1 to 40 micrometers.

The particulate poly(phenylene ether) can have a mean particle size of 15 micrometers, 10 micrometers, or 6 micrometers. The particulate poly(phenylene ether) can have a mean particle size of 6.07 micrometers and a standard deviation of 2.3 micrometers, a mean particle size of 10.9 micrometers and a standard deviation of 4.7 micrometers, or a mean particle size of 15.7 micrometers and a standard deviation of 5.9 micrometers.

Ninety percent of the particle volume distribution of the particulate poly(phenylene ether) can be less than 23 micrometers, less than 17 micrometers, or less than 8 micrometers. In some embodiments, 90 percent of the particle volume distribution of the particulate poly(phenylene ether) is less than 8 micrometers. Fifty percent of the particle volume distribution of the particulate poly(phenylene ether) can be less than 15 micrometers, less than 10 micrometers, or less than 6 micrometers. Ten percent of the particle volume distribution of the particulate poly(phenylene ether) can be less than 9 micrometers, less than 6 micrometers, or less than 4 micrometers.

It can be desirable to avoid poly(phenylene ether) particles less than or equal to 38 nanometers in diameter, because these particles pose an explosion hazard. Thus in some embodiments, less than 10%, specifically less than 1%, and more specifically less than 0.1%, of the particle volume distribution is less than or equal to 38 nanometers.

It is desirable that the particulate poly(phenylene ether) has a mean particle size of 1 to 100 micrometers, specifically 1 to 40 micrometers. When within these mean particle size ranges, the particulate poly(phenylene ether) does not adversely affect the viscosity of the intumescent coating composition. Also, when within these mean particle size ranges, the particulate poly(phenylene ether) does not adversely affect the physical, mechanical, and esthetic properties of the coating film. For example, above a mean particle size of 100 micrometers, the poly(phenylene ether) can adversely affect the strength, toughness, and integrity of the coating film. The coating film can also have a rough appearance, especially when the mean particle size of the poly(phenylene ether) particles approaches the coating film thickness, and the poly(phenylene ether) particles begin to protrude above the surface of the coating film.

Particulate poly(phenylene ether) can be obtained according to methods readily available to the skilled artisan, for example by jet milling, ball milling, pulverizing, air milling, or grinding commercial grade poly(phenylene ether). “Classification” is defined as the sorting of a distribution of particles to achieve a desired degree of particle size uniformity. A classifier is often used together with milling for the continuous extraction of fine particles from the material being milled. The classifier can be, for example, a screen of certain mesh size on the walls of the grinding chamber. Once the milled particles reach sizes small enough to pass through the screen, they are removed. Larger particles retained by the screen remain in the milling chamber for additional milling and size reduction.

Air classification is another method of removing the finer particles from milling. Air classifiers include static classifiers (cyclones), dynamic classifiers (single-stage, multi-stage), cross-flow classifiers, and counter-flow classifiers (elutriators). In general, a flow of air is used to convey the particles from the mill to the classifier, where the fine particles are further conveyed to a collector. The course particles, being too heavy to be carried by the air stream, are returned to the mill for further milling and size reduction. In larger operations, air classification is more efficient, while in smaller operations a screen can be used.

In some embodiments, the intumescent coating composition comprises 1 to 40 weight percent, specifically 5 to 30 weight percent, and more specifically 5 to 20 weight percent of particulate poly(phenylene ether), based on the total weight of the poly(phenylene ether), the film-forming binder, the acid source, and the blowing agent.

The intumescent coating composition comprises a film-forming binder. The film-forming binder is a resin or mixture of resins that is capable of forming a coating film adhered to a surface, and which binds the other components of the intumescent coating composition together upon drying or curing. Thus, a coating film derived from the intumescent coating composition comprises: a) a continuous phase comprising the film-forming binder or a cured product of the film-forming binder; and b) a disperse phase comprising the particulate poly(phenylene ether), wherein the particulate poly(phenylene ether) has a mean particle size of 1 to 40 micrometers. The binder can comprise thermoplastic resins, thermosetting resins, elastomeric resins, and a combination thereof. Examples of thermoplastic resins are (meth)acrylic resins, poly(vinyl acetate, vinyl acetate-(meth)acrylic copolymers, ethylene-vinyl acetate copolymers, ethylene-vinyl acetate-vinyl chloride terpolymers, cellulosic resins, polyvinyl chloride, polyvinylidene chloride, fluoropolymers, and a combination thereof. As used herein, “(meth)acrylic” refers to both “acrylic and methacrylic”, and “(meth)acrylate” refers to both “acrylate” and “methacrylate”. The (meth)acrylic resins can comprise (meth)acrylic acid units, (meth)acrylate esters, or a combination thereof.

Thermosetting resins can comprise self-crosslinking resins, for example cyanate esters, unsaturated polyesters, alkyds, amino resins, melamine-formaldehyde resins, urea-formaldehyde resins, phenol-formaldehyde resins, and silicone resins. Thermosetting resins can also comprise a combination of a crosslinker and a resin reactive with the crosslinker, for example a hardener and an epoxy resin, or a (meth)acrylic or polyester polyol and a polyisocyanate (forming an acrylic urethane or polyester urethane upon curing). Examples of elastomeric resins are thermoplastic polyurethanes, thermoplastic polyamides, thermoplastic copolyetheresters, and chlorinated rubbers.

In some embodiments, the film-forming binder is selected from the group consisting of (meth)acrylic resins, poly(vinyl acetate), vinyl acetate-(meth)acrylic copolymers, ethylene-vinyl acetate copolymers, ethylene-vinyl acetate-vinyl chloride terpolymers, polyurethanes, polyisocyanurates, polyesters, polyamides, cellulosic resins, polyvinyl chloride, polyvinylidene chloride, fluoropolymers, epoxy resins, unsaturated polyesters, alkyds, amino resins, melamine-formaldehyde resins, urea-formaldehyde resins, phenol-formaldehyde resins, silicone resins, cyanate esters, curable ethylenically unsaturated monomers, thermoplastic polyurethanes, thermoplastic polyamides, thermoplastic copolyetheresters, chlorinated rubbers, and a combination thereof. In some embodiments, the film-forming binder does not comprise poly(phenylene ether).

In some embodiments, the intumescent coating composition comprises 50 to 90 weight percent, specifically 60 to 80 weight percent, of the film-forming binder, based on the total weight of the poly(phenylene ether), the film-forming binder, the acid source, and the blowing agent.

The intumescent coating composition comprises an acid source. The acid source is an acid, or a material that under the high temperature conditions of a fire, generates an acid, for example phosphoric acid, a phosphonic acid, sulfuric acid, nitric acid, boric acid, or hydrochloric acid. In some embodiments, the acid source comprises is selected from the group consisting of monoammonium phosphate, diammonium phosphate, monopotassium phosphate, ammonium polyphosphate, metaphosphoric acid, orthophosphoric acid, pyrophosphoric acid, hypophosphorous acid, melamine phosphate, melamine pyrophosphate, melamine polyphosphate, melamine pentaerythritol diphosphate, ammonium sulfate, ammonium chloride, boric acid, and a combination thereof.

In some embodiments, the acid source is a water-insoluble ammonium polyphosphate having polymeric P—O—P linkages, essentially no P—N—P linkages, and essentially no orthophosphate, pyrophosphate, or short-chain P—O—P linkages. Essentially all of the nitrogen is in the form of ammonium ions. The ammonium polyphosphate has the formula

(NH₄)ₘ₊₂PₘO₃ₘ₊₁

wherein m is an integer having an average value of about 1000 to about 3000 Ammonium polyphosphate is available as PHOSCHEK™ P30 from ICL Performance Products LP, St. Louis, Mo., and has a solubility of about 1 to about 5 grams per 100 milliliters of water, measured by slurrying 10 grams of ammonium polyphosphate in 100 millimeters of water for 60 minutes at 25° C. Ammonium polyphosphate is also available as EXOLIT™ AP 422, from Clariant.

In some embodiments, the intumescent coating composition comprises 4 to 60 weight percent, specifically 10 to 40 weight percent, of the acid source, based on the total weight of the poly(phenylene ether), the film-forming binder, the acid source, and the blowing agent.

The intumescent coating composition comprises a blowing agent. Blowing agents are compounds which produce non-flammable gases when they undergo thermal decomposition. The blowing agent provides one means for the expansion of char produced from the carbon source by fire or heat to form an insulating cellular structure. The blowing agent increases the thickness of the carbon char when exposed to fire or heat by thermal decomposition and concurrent evolution of a non-combustible gas. For example, melamine undergoes self-condensation reactions above its melting point of 350-400° C., generating ammonia; chlorinated paraffin waxes generate hydrochloric acid; and aluminum trihydrate generates water.

The expansion of the char and formation of a cellular structure enhances the insulating properties of the coating. Furthermore, the blowing agent absorbs energy when it evolves a gas, thereby removing energy from the surface and cooling the substrate. The non-combustible gas also dilutes the concentrations of combustible gasses that are produced in a fire and dilutes the concentration of oxygen in the atmosphere adjacent to the substrate. In some embodiments, the blowing agent is selected from the group consisting of melamine, melamine polyphosphate, melamine cyanurate, melamine isocyanurate, tris(hydroxyethyl) isocyanurate, dicyandiamide, urea, dimethylurea, guanidine, cyanoguanidine, glycine, chlorinated paraffin wax, alumina trihydrate, magnesium hydroxide, zinc borate hydrate, and a combination thereof. Examples of chlorinated paraffin waxes are CHLOROWAX™ 700 and CHLOREZ™ 700, available from Dover Chemical Corp., Dover, Ohio. CHLOROWAX™ 700 and CHLOREZ™ 700 have the chemical formula C₂₄H₂₈Cl₂₂, a chlorine content of 71.5 weight percent, a softening point of 103° C., and a specific gravity of 1.66 at 25° C.

The coating composition can comprise a mixture of blowing agents with different decomposition temperatures. An example of a mixture of blowing agents is at least one chlorine-containing blowing agent which decomposes at a lower temperature, for example a chlorinated paraffin wax, and at least one nitrogen-containing blowing agent which decomposes at a higher temperature, for example melamine, dicyandiamide, urea, or guanidine. A specific combination is CHLOREZ™ 700 and melamine. CHLOREZ™ 700 decomposes above 180° C., releasing hydrochloric acid gas, while melamine sublimes above about 200° C., and decomposes above 350° C., releasing ammonia gas.

In some embodiments, the intumescent coating composition comprises 1 to 30 weight percent, specifically 5 to 20 weight percent, of the blowing agent, based on of the total weight of the poly(phenylene ether), the film-forming binder, the acid source, and the blowing agent.

Polyolefins, homopolystyrenes, rubber-modified polystyrenes, styrene-containing copolymers, and hydrogenated and unhydrogenated block copolymers of an alkenyl aromatic compound and a conjugated diene are all absent from the composition. Polyolefins are polymers produced from an olefin monomer having the general formula CₙH₂ₙ. Polyolefins can be thermoplastic or elastomeric. Examples of thermoplastic polyolefins are polyethylene (PE), polypropylene (PP), and polybutene-1 (PB-1). Examples of elastomeric polyolefins are polyisobutylene (PIB), ethylene-propylene rubber (EPR), and ethylene-propylene-diene monomer rubber (EPDM rubber).

Depending on temperature, pressure, catalyst, and the use of a comonomer, three types of polyethylene can be produced: high-density polyethylene (HDPE), low-density polyethylene (LDPE), and linear low-density polyethylene (LLDPE). LLDPE is prepared by copolymerization of ethylene with an α-olefin. In this way, branching is introduced in a controlled manner with branches of uniform chain length. LLDPE comonomers include 1-butene, 1-hexene, 1-octene, and 4-methyl-1-pentene (4M1P). Specialty grades of polyethylene include very low density (VLDPE), medium density (MDPE), and ultra-high molecular weight (UHMWPE) polyethylene.

Homopolystyrenes, i.e. homopolymers of styrene, are absent from the composition. In some embodiments, the homopolystyrene has a number average molecular weight of 10,000 to 200,000 atomic mass units, specifically 30,000 to 100,000 atomic mass units. The styrene homopolymer can be atactic, isotactic, or syndiotactic. In some embodiments, the homopolystyrene is an atactic homopolystyrene. The atactic homopolystyrene can have a melt flow index of 0.5 to 10 grams per 10 minutes, specifically 1 to 5 grams per 10 minutes, measured at 200° C. and a 5-kilogram load according to ASTM D1238. The atactic homopolystyrene can have a mineral oil content of less than or equal to 5 weight percent, specifically less than or equal to 2 weight percent. In a specific embodiment, the polystyrene is an atactic homopolystyrene having a number average molecular weight of 30,000 to 100,000 atomic mass units.

Rubber-modified polystyrenes, comprising polystyrene and polybutadiene, are absent from the composition. Rubber-modified polystyrenes are sometimes referred to as “high-impact polystyrenes” or “HIPS”. In some embodiments, the rubber-modified polystyrene comprises 80 to 96 weight percent polystyrene, specifically 88 to 94 weight percent polystyrene; and 4 to 20 weight percent polybutadiene, specifically 6 to 12 weight percent polybutadiene, based on the weight of the rubber-modified polystyrene. In some embodiments, the rubber-modified polystyrene has an effective gel content of 10 to 35 percent. An example of a rubber-modified polystyrene is GEH HIPS 1897, available from SABIC Innovative Plastics.

Hydrogenated block copolymers of an alkenyl aromatic compound and a conjugated diene are absent from the composition. For brevity, this component is referred to herein as a “hydrogenated block copolymer”. The hydrogenated block copolymer generally comprises 10 to 45 weight percent poly(alkenyl aromatic) content, based on the weight of the hydrogenated block copolymer. Within this range, the poly(alkenyl aromatic) content can be 20 to 40 weight percent, specifically 25 to 35 weight percent.

In some embodiments, the hydrogenated block copolymer has a weight average molecular weight of at least 100,000 atomic mass units. In some embodiments the hydrogenated block copolymer comprises a polystyrene-poly(ethylene-butylene)-polystyrene triblock copolymer having a weight average molecular weight of 100,000 to 1,000,000 atomic mass units, specifically 100,000 to 400,000 atomic mass units.

The alkenyl aromatic monomer used to prepare the hydrogenated block copolymer can have the structure

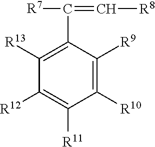

wherein R⁷ and R⁸ each independently represent a hydrogen atom, a C₁-C₈ alkyl group, or a C₂-C₈ alkenyl group; R⁹ and R¹³ each independently represent a hydrogen atom, a C₁-C₈ alkyl group, a chlorine atom, or a bromine atom; and R¹⁰, R¹¹ and R¹² each independently represent a hydrogen atom, a C₁-C₈ alkyl group, or a C₂-C₈ alkenyl group, or R¹⁰ and R¹¹ are taken together with the central aromatic ring to form a naphthyl group, or R¹¹ and R¹² are taken together with the central aromatic ring to form a naphthyl group. Specific alkenyl aromatic monomers include, for example, styrene, chlorostyrenes such as p-chlorostyrene, methylstyrenes such as alpha-methylstyrene and p-methylstyrene, and t-butylstyrenes such as 3-t-butylstyrene and 4-t-butylstyrene. In some embodiments, the alkenyl aromatic monomer is styrene.

The conjugated diene used to prepare the hydrogenated block copolymer can be a C₄-C₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and a combination thereof. In some embodiments, the conjugated diene is 1,3-butadiene, 2-methyl-1,3-butadiene, or a combination thereof. In some embodiments, the conjugated diene consists of 1,3-butadiene.

The hydrogenated block copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In some embodiments, the aliphatic unsaturation in the (B) block is reduced by at least 50 percent, specifically at least 70 percent. The arrangement of blocks (A) and (B) includes a linear structure, a grafted structure, and a radial teleblock structure with or without a branched chain. Linear block copolymers include tapered linear structures and non-tapered linear structures. In some embodiments, the hydrogenated block copolymer has a tapered linear structure. In some embodiments, the hydrogenated block copolymer has a non-tapered linear structure. In some embodiments, the hydrogenated block copolymer comprises a (B) block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of (A) and (B), wherein the molecular weight of each (A) block can be the same as or different from that of other (A) blocks, and the molecular weight of each (B) block can be the same as or different from that of other (B) blocks. In some embodiments, the hydrogenated block copolymer is a diblock copolymer, a triblock copolymer, or a combination thereof.

In some embodiments, the hydrogenated block copolymer excludes the residue of monomers other than the alkenyl aromatic compound and the conjugated diene. In some embodiments, the hydrogenated block copolymer consists of blocks derived from the alkenyl aromatic compound and the conjugated diene. It does not comprise grafts formed from these or any other monomers. It also consists of carbon and hydrogen atoms and therefore excludes heteroatoms. In some embodiments, the hydrogenated block copolymer includes the residue of one or more acid functionalizing agents, such as maleic anhydride. In some embodiments, the hydrogenated block copolymer comprises a polystyrene-poly(ethylene-butylene)-polystyrene triblock copolymer.

Methods for preparing hydrogenated block copolymers are known in the art and many hydrogenated block copolymers are commercially available. Illustrative commercially available hydrogenated block copolymers include the polystyrene-poly(ethylene-propylene) diblock copolymers available from Kraton Polymers as KRATON™ G1701 (having 37 weight percent polystyrene) and G1702 (having 28 weight percent polystyrene); the polystyrene-poly(ethylene-butylene)-polystyrene triblock copolymers available from Kraton Polymers as KRATON™ G1641 (having 33 weight percent polystyrene), G1651 (having 31-33 weight percent polystyrene), and G1654 (having 31 weight percent polystyrene); and the polystyrene-poly(ethylene-ethylene/propylene)-polystyrene triblock copolymers available from Kuraray as SEPTON™ 54044, 54055, 54077, and 54099. Additional commercially available hydrogenated block copolymers include polystyrene-poly(ethylene-butylene)-polystyrene (SEBS) triblock copolymers available from Dynasol as CALPRENE™ CH-6170, CH-7171, CH-6174 and CH-6140, and from Kuraray as SEPTON™ 8006 and 8007; polystyrene-poly(ethylene-propylene)-polystyrene (SEPS) copolymers available from Kuraray as SEPTON™ 2006 and 2007; and oil-extended compounds of these hydrogenated block copolymers available from Kraton Polymers as KRATON™ G4609 and G4610 and from Asahi as TUFTEC™ H1272. Mixtures of two of more hydrogenated block copolymers can be used. In some embodiments, the hydrogenated block copolymer comprises a polystyrene poly(ethylene-butylene)-polystyrene triblock copolymer having a weight average molecular weight of at least 100,000 atomic mass units.

Unhydrogenated block copolymers are absent from the composition. Unhydrogenated block copolymers are similar to the hydrogenated block copolymers described above, except that the aliphatic unsaturation of the poly(conjugated diene) blocks is not hydrogenated. Unhydrogenated block copolymers include, for example, polystyrene-polybutadiene diblock copolymers, polystyrene-polybutadiene-polystyrene triblock copolymers, polystyrene-polyisoprene diblock copolymers, polystyrene-polyisoprene-polystyrene triblock copolymers, and a combination thereof. Unhydrogenated block copolymers are known in the art, and are described, for example, in Gerard Riess, G. Hurtrez, and P. Bahadur, Block Copolymers, 2 Encyclopedia of Polymer Science and Engineering, 324 (H. F. Mark et al. eds., 1985), incorporated herein by reference. They may be either pure block copolymers or tapered (overlap) copolymers. Tapered styrene-rubber block copolymers have an area of the polymer between the styrene and rubber blocks in which both monomer units are present. The taper area is thought to exhibit a gradient, from a styrene-rich area closest to the styrene block to a rubber-rich area closest to the rubber block.

In some embodiments, the intumescent coating composition comprises a carbon source other than the particulate poly(phenylene ether). As used herein, a “carbon source” is an organic material that produces char when heated above its decomposition temperature. Examples of carbon sources are polyols, polysaccharides, starches, dextrins, sugar alcohols, reducing sugars, hexane hexyls, pentane pentols, amino resins, chlorinated paraffin waxes, expandable graphite, and a combination thereof. In some embodiments, the intumescent coating composition further comprises a carbon source selected from the group consisting of mannitol, sorbitol, dulcitol, inositol, arabitol, pentaerythritol, dipenterythritol, tripentaerythritol, sucrose, glucose, dextrose, starch, dextrins, polyvinyl alcohols, melamine-formaldehyde resins, urea-formaldehyde resins, ethyleneurea-formaldehyde resins, chlorinated paraffin waxes, expandable graphite, and a combination thereof.

The amount of carbon source can be 0 to 40 weight percent, specifically 1 to 40 weight percent, more specifically 5 to 30 weight percent, and still more specifically 5 to 20 weight percent, based on the total weight of the poly(phenylene ether), the carbon source, the film-forming binder, the acid source, and the blowing agent.

An intumescent coating component can serve more than one function. For example, the polyphosphate component of melamine polyphosphate can serve as a source of phosphoric acid and the melamine component can serve as a blowing agent. Chlorinated paraffin wax can serve as a carbon source and a blowing agent, because it decomposes to char as it releases hydrochloric acid as the blowing agent.

In some embodiments, the intumescent coating composition further comprise a flame retardant other than the poly(phenylene ether), the acid source, the blowing agent, and the carbon source. Other flame retardants include brominated organic compounds and polymers, phosphate esters, chloroalkyl phosphate esters, phosphonate esters, phosphinate esters, expandable graphite, metal oxides, hydrated metal oxides, ammonium salts, silicates, and a combination thereof.

Brominated organic compounds include tetrabromophthalate esters, decabromodiphenyl oxide, tetrabromobenzoate esters, tetrabromobisphenol A, tetrabromobisphenol A ethers, poly(dibromostyrene), hexabromocyclodecane, decabromodiphenyhlethane, 2,4,6-tribromophenol, bis(2,4,6-tribromophenoxy)ethane, and a combination thereof. Phosphate esters include triethyl phosphate, cresyl diphenyl phosphate, tricresyl phosphate, trixylyl phosphate, isopropylated triaryl phosphates, bisphenol A bis(diphenyl phosphate), resorcinol bis(diphenyl phosphate), and a combination thereof. Chloroalkyl phosphate esters include tris(2-chloroisopropyl)phosphate, tris(1,3-dichloroisopropyl)phosphate, tris(2-chloroethyl)phosphate, and a combination thereof. Phosphonate esters include diethyl N,N-bis(2-hydroxyethyl)aminoethyl phosphonate. Phosphinate esters include aluminum diethyl phosphinate, zinc diethyl phosphinate, and a combination thereof. Metal oxides include magnesium hydroxide, antimony trioxide, sodium antimonite, and a combinations thereof. Hydrated metal oxides include aluminum trihydrate, sodium deacaborate decahydrate, zinc borate hydrate, and a combination thereof. Ammonium salts include ammonium pentaborate, ammonium sulfate, ammonium bisulfate, ammonium chloride, and a combination thereof. Silicates are solid compounds containing silicon atoms covalently bonded to four oxygen atoms to form tetrahedral SiO₄ repeat units. One or more oxygen atoms of the subunit can bridge to one or more metal atoms. Examples of silicates include the sodium exchange form of zeolite type A and the sodium exchange form of montmorillonite clay.

The amount of flame retardant, when present, can be 0.1 to 50 weight percent, specifically 0.5 to 20 weight percent, and more specifically 1 to 10 weight percent, based on the dry weight of the intumescent coating composition.

In some embodiments, the intumescent coating composition further comprises a filler. Fillers are also referred to as inert pigments or extenders. Fillers can be used to adjust the rheological properties of the coating composition, for example as thickeners, to reduce settling of pigments, and to improve brushability or flow properties. Fillers can also be used to modify the properties of coating films, e.g. to reduce gloss, to increase the opacity of white-hiding pigments, and to improve barrier properties. Fillers can also serve as reinforcing agents to improve the strength and toughness of coating films. Inexpensive fillers can be used to occupy volume in the coating film, thereby reducing coating cost.

Fillers include calcium carbonate, baryte, gypsum, silica, fumed silica, diatomaceous earth, alumina, calcium silicate, perlite, wollastonite, China clay, talc, mica, feldspar, nepheline syenite, kaolinite, bentonite, montmorillonite, attapulgite, pyrophyllite, zeolites, glass spheres, and a combination thereof.

The filler can be a reinforcing filler. Reinforcing fillers can be in the shape of fibers, acicular crystals, whiskers, flakes, plates, or have irregular shapes. The average aspect ratio for fibrous, acicular, and whisker-shaped fillers is defined as length:diameter. The average aspect ratio of flaked and plate-like fillers is defined as average diameter of a circle of the same area:average thickness. The average aspect ratio can be greater than 1.5, specifically greater than 3.

The reinforcing filler can be a fibrous filler such as glass fibers, carbon fibers, organic fibers, metal fibers, ceramic fibers, whiskers, or the like. Fibrous fillers include short inorganic fibers such as those derived from blends comprising at least one of aluminum silicates, aluminum oxides, magnesium oxides, and calcium sulfate hemihydrate. Other fibrous fillers include natural fillers, such as wood flour obtained by pulverizing wood, and fibrous products such as cellulose, cotton, sisal, jute, starch, cork flour, lignin, ground nut shells, corn, and rice grain husks. Also included among fibrous fillers are single crystal fibers or whiskers, including silicon carbide, alumina, boron carbide, iron, nickel, and copper whiskers.

Fibrous fillers include organic polymer fibers. Organic polymer fibers include poly(ether ketone), polyimide, polybenzoxazole, poly(phenylene sulfide), polyesters, polyethylene, aromatic polyamides, aromatic polyimides or polyetherimides, polytetrafluoroethylene, acrylic resins, and poly(vinyl alcohol) fibers. These fibers are available in the form of monofilament or multifilament fibers and can be used either alone or in combination with other types of fiber, through, for example, co-weaving or core/sheath, side-by-side, orange-type or matrix and fibril constructions. Cowoven structures include glass fiber-carbon fiber, carbon fiber-aromatic polyimide (aramid) fiber, and aromatic polyimide fiber-glass fiber. Fibrous fillers can be supplied in the form of, for example, rovings, woven fibrous reinforcements, such as 0-90 degree fabrics, non-woven fibrous reinforcements such as continuous strand mat, chopped strand mat, tissues, papers and felts and 3-dimensionally woven reinforcements, performs, and braids.

The reinforcing filler can be in the shape of flakes or plates. Flaked or plate-like fillers include glass flakes, silicon carbide flakes, aluminum diboride flakes, aluminum flakes, steel flakes, mica, vermiculite, and the like.

The amount of filler, when present, can be 0.1 to 50 weight percent, specifically 0.5 to 20 wt %, and more specifically 1 to about 10 weight percent, based on the dry weight of the coating composition.

In some embodiments, the intumescent coating composition further comprises 0.1 to 50 weight percent, based on the dry weight of the composition, of a filler selected from the group consisting of calcium carbonate, baryte, gypsum, silica, diatomaceous earth, alumina, calcium silicate, perlite, wollastonite, talc, mica, feldspar, nepheline syenite, kaolinite, bentonite, montmorillonite, attapulgite, pyrophyllite, glass fiber, carbon fiber, organic polymer fibers, and a combination thereof.

In some embodiments, the intumescent coating composition further comprises a solvent, wherein that the solvent does not dissolve all of the particulate poly(phenylene ether). Examples of suitable solvents are water, aliphatic and aromatic hydrocarbons, halogenated aliphatic hydrocarbons, aliphatic ethers, aliphatic nitriles, cyclic ethers, glycols, glycol ethers, esters, ketones, alcohols, amides, sulfoxides, or a combination thereof. Specific examples of solvents are water, pentane, hexane, octane, toluene, xylene, cyclohexanone, methyl ethyl ketone, methyl isobutyl ketone, ethanol, isopropyl alcohol, n-butanol, ethylene glycol, propylene glycol, N,N-dimethylformamide, dimethylsulfoxide, diethyl ether, tetrahydrofuran, 1,4-dioxane, ethylene glycol dimethyl ether, diethylene glycol methyl ether, diethylene glycol dimethyl ether (diglyme), monobutyl ethylene glycol ether, dipropylene glycol methyl ether, N-methylpyrrolidinone, N,N-dimethylacetamide, acetonitrile, sulfolane, and a combination thereof. The solubility of the particulate poly(phenylene ether) in the solvent is less than or equal to 10 weight percent, specifically less than or equal to 5 weight percent, more specifically less than or equal to 1 weight percent, and still more specifically less than or equal to 0.1 weight percent, based on the total weight of the particulate poly(phenylene ether) and the solvent, at the mixing temperature.

In some embodiments, the intumescent coating composition further comprises an additive other than flame retardants, fillers, and solvents. The additive can include coalescing agents, reactive diluents, curing agents, pigments, dyes, plasticizers, compatibilizing agents, dispersants, surfactants, anionic surfactants, nonionic surfactants, cationic surfactants, inorganic phosphate surfactants, rheology modifiers, leveling agents, wetting agents, dispersants, defoamers, thickeners, adhesion promoters, antistatic agents, anti-corrosion agents, stabilizers, ultraviolet absorbers, hindered amine light stabilizers, antioxidants, preservatives, biocides, mildewcides, buffers, neutralizers, dulling agents, fluorocarbons, silicone oils, antioxidants, and a combination thereof. In some embodiments, the intumescent coating composition comprises clay, fumed silica, mica, talc, zeolites, titanium dioxide, zinc oxide, glass fibers, glass spheres, chicken eggshell, ceramic additives, and a combination thereof.

In some embodiments, the intumescent coating composition comprises (a) 10 to 40 weight percent of poly(2,6-dimethyl-1,4-phenylene ether) having a mean particle size of 1 to 10 micrometers; (b) 30 to 50 weight percent of the film-forming binders elected from the group consisting of epoxy resins, cyanate ester resins, thermoplastic polyurethanes, acrylic resins, and a combination thereof; (c) 20 to 40 weight percent of ammonium polyphosphate; and (d) 5 to 30 weight percent of melamine, wherein all weight percents are based on the total weight of the poly(2,6-dimethyl-1,4-phenylene ether), the film-forming binder, the ammonium polyphosphate, and the melamine. In some embodiments, this intumescent coating composition further comprises 1 to 20 weight percent, based on the total weight of the poly(2,6-dimethyl-1,4-phenylene ether), the film-forming binder, the ammonium polyphosphate, the melamine, and the carbon source, of a carbon source selected from the group consisting of pentaerythritol, dipentaerythritol, and a combination thereof.

The intumescent coating composition can be in the form of a liquid, an emulsion, a dispersion, a suspension, a particulate solid, or a polymer melt. Liquid coatings can be 100% solids (no volatile solvents), solvent-borne (dissolved or dispersed in organic solvent) or water-borne (dissolved or dispersed in water). Particulate solid coatings are known as powder coatings. The coating composition can be in the form of a dispersion with a polymer melt as the continuous phase, in which the polymer is the film-forming binder, and the melt temperature is below the glass transition temperature of the poly(phenylene ether). The intumescent coating composition can also be a mastic, which is a high viscosity coating or adhesive that can be applied to form a thick coating film of 0.25 to 10 millimeters.

A method of forming the intumescent coating composition comprises: mixing the particulate poly(phenylene ether), the film-forming binder, the acid source, the blowing agent, and optionally the carbon source other than the particulate poly(phenylene ether); wherein the particulate poly(phenylene ether) has a glass transition temperature, and wherein the mixing is carried out at a temperature below the glass transition temperature of the particulate poly(phenylene ether). It is desirable that the intumescent coating composition is formed below the glass transition temperature of the poly(phenylene ether). For example, when the poly(phenylene ether) is poly(2,6-dimethyl-4-phenylene ether), it is desirable to carry out the mixing below 215° C., the glass transition temperature of poly(2,6-dimethyl-4-phenylene ether). At or above the glass transition temperature, the poly(phenylene ether) particles can agglomerate and congeal into larger domains, which are not as well dispersed in the film-forming binder. When the poly(phenylene ether) is dispersed in the coating film as domains having a mean size greater than 100 micrometers, specifically greater than 40 micrometers, the strength, toughness, integrity, and appearance of the coating film can be adversely affected.

The particulate poly(phenylene ether), the film-forming binder, the acid source, and the blowing agent, can be mixed in any order. However it can be advantageous to avoid adding the particulate poly(phenylene ether) in any step wherein solid components, for example the acid source, the blowing source, and/or the carbon source, are milled. In this way, the poly(phenylene ether) is subjected to the minimum amount of shear forces and heating from milling, and there will be minimal effect on the mean particle size and particle size distribution of the particulate poly(phenylene ether).

In some embodiments, a method of forming the intumescent coating composition comprises mixing the acid source and the blowing agent to form a first mixture; mixing the film-forming binder and the first mixture to form a second mixture; and mixing the particulate poly(phenylene ether) and the second mixture to form the coating composition.

Any solid components, including the particulate poly(phenylene ether), the acid source, blowing agent, pigments, fillers, and a combination thereof, can be mixed by milling in the solid state. Milling methods include jet milling, ball milling, pulverizing, air milling, and grinding. Jet milling, as applied to poly(phenylene ether), is described above. The heat generated during milling should not be high enough to cause decomposition or reaction of the acid source, blowing agent, and any other solid components present. The solid components can also be dispersed in water, organic solvent, or a combination thereof, in the presence of plasticizer, compatibilizing agent, dispersant, surfactant, inorganic phosphate surfactant, buffer, defoamer, or a combination thereof, and mixed by the application of shear forces exerted by, for example, axial flow impellers or radial flow impellers. Alternately, the solid components can be mixed in molten film-forming binder by shear forces, extensional forces, compressive forces, or a combination thereof. These forces can be exerted, for example, by single screws, multiple screws, intermeshing co-rotating or counter-rotating screws, non-intermeshing co-rotating or counter-rotating screws, reciprocating screws, screws with pins, screws with screens, barrels with pins, rolls, rams, helical rotors, or a combination thereof. It is desirable that mixing temperatures high enough to cause decomposition or reaction of the acid source, blowing agent, and any other components present, be avoided. It is also desirable that the mixing temperature be below the glass transition temperature of the particulate poly(phenylene ether) to prevent agglomeration of the poly(phenylene ether) particles.

A method of protecting an article against fire comprises applying the intumescent coating composition to at least one surface of the article, and drying or curing the composition to form a coating film. Depending on its physical form and viscosity at the application temperature, the intumescent coating composition can be applied to the article, or to the article coated with one or more other coating layers, by known methods including brush coating, roll coating, curtain coating, dip coating, and spraying methods such as electrostatic spray, hot/flame spray, air-atomized spray, air-assisted spray, airless spray, high volume low pressure spray, low volume low pressure spray, and air-assisted airless spray. When the intumescent coating composition is a powder coating, the coating can be applied, for example, by electrostatic spray, fluidized bed coating, electrostatic fluidized bed coating, or electrostatic magnetic brush coating.

When the intumescent coating composition is a solvent-borne or water-borne thermoplastic, the composition can be dried, or allowed to dry, at a temperature of 0 to 100° C., specifically 20 to 90° C., for 30 seconds to 10 days, depending on the drying temperature. When the intumescent coating composition is a thermoset, the composition can be cured at a temperature of 0 to 300° C., specifically 20 to 250° C., and more specifically 20 to 200° C., for 30 seconds to 10 days, depending on the curing temperature.

The coating film derived from the intumescent coating composition comprises: (a) a continuous phase comprising the film-forming binder or a cured product of the film-forming binder; and (b) a disperse phase comprising the particulate poly(phenylene ether), wherein the particulate poly(phenylene ether) has a mean particle size of 1 to 40 micrometers.

A coated article comprises the coating film derived from the intumescent coating composition adhered to the article. The coating film can have a thickness of 0.25 to 10 millimeters. The thickness depends on the level of fire protection required. With solvent-borne or water-borne coating compositions, the higher dry film thicknesses can only be achieved by the application of multiple coats.

In some embodiments, the article is structural steel. The intumescent coating compositions can be used to protect structural steel components in buildings (or any other steel supported structure) against the effects of any fire conditions including cellulosic, hydrocarbon and Jetfire conditions. The char produced by the coating film derived from the intumescent coating composition greatly reduces the rate of heating experienced by the steel, thus extending the time before the steel loses its integrity and the building or structure collapses, thereby allowing additional time for safe evacuation.

In a fire, a steel structure will heat up, the rate of heating depending on the specific dimensions of the steel sections used in the structure. The rate of heating is dependent on the Hp/A value of the section, where Hp is the perimeter of the steel when viewed in cross-section, and A is the cross-sectional area. A steel section with a large perimeter (Hp) will receive more heat than one with a smaller perimeter. On the other hand, the greater the cross-sectional area (A), the more heat the steel section can absorb. Thus, a large thin steel section having a high Hp/A value will heat up more quickly than a small thick section having a lower Hp/A value.

The target thickness of the coating film depends on the Hp/A value of the steel, its configuration, and the level of fire protection required. The level of fire protection is defined by the time required for the steel to reach its critical failure temperature (550° C.) under standard test conditions, and the time can be from 30 to 120 minutes. There can be variations in the failure temperature. For example, if the steel section is in a horizontal plane (beam), as opposed to a vertical plane (column), then the failure temperature is usually higher (around 620° C. for the beam compared to 550° C. for the column). Also, the failure temperature can depend on the type of fire to protect against. For example if a hydrocarbon fire is the concern, an extra safety margin is factored in, and a failure temperature of 400° C. is assumed.

The present inventors have discovered that particulate poly(phenylene ether) can partially or completely replace the carbon source, such as pentaerythritol or dipentaerythritol, in intumescent coating compositions. Advantageously, the intumescent coating composition, in which particulate poly(phenylene ether) partially or completely replaces the carbon source, provides a higher char yield, compared to compositions lacking the poly(phenylene ether). Moreover, when the particulate poly(phenylene ether) has a mean particle size of 1 to 100 micrometers, specifically 1 to 40 micrometers, the strength, toughness, integrity, and appearance of the coating film are not adversely affected. The particulate poly(phenylene ether) can further provide improved dielectric properties and an improved moisture barrier for the coating film.

The invention includes at least the following embodiments.

### Embodiment 1

An intumescent coating composition comprising (a) particulate poly(phenylene ether), wherein the mean particle size of the poly(phenylene ether) is 1 to 100 micrometers; (b) a film-forming binder; (c) an acid source; (d) a blowing agent; and (e) optionally, a carbon source other than the particulate poly(phenylene ether); wherein polyolefins, homopolystyrenes, rubber-modified polystyrenes, styrene-containing copolymers, and hydrogenated and unhydrogenated block copolymers of an alkenyl aromatic compound and a conjugated diene are all absent from the composition.

### Embodiment 2

The intumescent coating composition of claim 1, wherein the carbon source is present, and is selected from the group consisting of mannitol, sorbitol, dulcitol, inositol, arabitol, pentaerythritol, dipenterythritol, tripentaerythritol, sucrose, glucose, dextrose, starch, dextrins, polyvinyl alcohols, melamine-formaldehyde resins, urea-formaldehyde resins, ethyleneurea-formaldehyde resins, chlorinated paraffin waxes, expandable graphite, and a combination thereof

### Embodiment 3

The intumescent coating composition of embodiment 1 or 2, comprising: (a) 1 to 40 weight percent of the poly(phenylene ether); (b) 50 to 90 weight percent of the film-forming binder; (c) 4 to 60 weight percent of the acid source; and (d) 1 to 30 weight percent of the blowing agent; wherein all weight percents are based on the total weight of the poly(phenylene ether), the film-forming binder, the acid source, and the blowing agent.

### Embodiment 4

The intumescent coating composition of any of embodiments 1-3, wherein the poly(phenylene ether) is poly(2,6-dimethyl-1,4-phenylene ether).

### Embodiment 5

The intumescent coating composition of any of embodiments 1-4, wherein the film-forming binder does not comprise poly(phenylene ether).

### Embodiment 6

The intumescent coating composition of any of embodiments 1-5, wherein the film-forming binder is selected from the group consisting of (meth)acrylic resins, poly(vinyl acetate), vinyl acetate-(meth)acrylic copolymers, ethylene-vinyl acetate copolymers, ethylene-vinyl acetate-vinyl chloride terpolymers, polyurethanes, polyisocyanurates, polyesters, polyamides, cellulosic resins, polyvinyl chloride, polyvinylidene chloride, fluoropolymers, epoxy resins, unsaturated polyesters, alkyds, amino resins, melamine-formaldehyde resins, urea-formaldehyde resins, phenol-formaldehyde resins, silicone resins, cyanate esters, curable ethylenically unsaturated monomers, thermoplastic polyurethanes, thermoplastic polyamides, thermoplastic copolyetheresters, chlorinated rubbers, and a combination thereof.

### Embodiment 7

The intumescent coating composition of any of embodiments 1-6, wherein the mean particle size of the poly(phenylene ether) is 1 to 40 micrometers.

### Embodiment 8

The intumescent coating composition of any of embodiments 1-7, wherein 90 percent of the particle volume distribution of the poly(phenylene ether) is less than 8 micrometers.

### Embodiment 9

The intumescent coating composition of any of embodiments 1-8, wherein the acid source is selected from the group consisting of monoammonium phosphate, diammonium phosphate, monosodium phosphate, disodium phosphate, monopotassium phosphate, dipotassium phosphate, ammonium polyphosphate, metaphosphoric acid, orthophosphoric acid, pyrophosphoric acid, hypophosphorous acid, melamine phosphate, melamine pyrophosphate, melamine polyphosphate, melamine pentaerythritol diphosphate, ammonium sulfate, ammonium chloride, boric acid, and a combination thereof

### Embodiment 10

The intumescent coating composition of any of embodiments 1-9, wherein the blowing agent is selected from the group consisting of melamine, melamine polyphosphate, melamine cyanurate, melamine isocyanurate, tris(hydroxyethyl) isocyanurate, dicyandiamide, urea, dimethylurea, guanidine, cyanoguanidine, glycine, chlorinated paraffin wax, alumina trihydrate, magnesium hydroxide, zinc borate hydrate, and a combination thereof.

### Embodiment 11

The intumescent coating composition of any of embodiments 1-10, further comprising 0.1 to 50 weight percent, based on the dry weight of the composition, of a flame retardant selected from the group consisting of brominated organic compounds and polymers, phosphate esters, chloroalkyl phosphate esters, phosphonate esters, phosphinate esters, expandable graphite, metal oxides, hydrated metal oxides, ammonium salts, silicates, and a combination thereof.

### Embodiment 12

The intumescent coating composition of any of embodiments 1-11, further comprising 0.1 to 50 weight percent, based on the dry weight of the composition, of a filler selected from the group consisting of calcium carbonate, baryte, gypsum, silica, diatomaceous earth, alumina, calcium silicate, perlite, wollastonite, talc, mica, feldspar, nepheline syenite, kaolinite, bentonite, montmorillonite, attapulgite, pyrophyllite, glass fiber, carbon fiber, organic polymer fibers, and a combination thereof.

### Embodiment 13

The intumescent composition of any of embodiments 1-12, comprising: (a) 10 to 40 weight percent of poly(2,6-dimethyl-1,4-phenylene ether) having a mean particle size of 1 to 10 micrometers; (b) 30 to 50 weight percent of a film-forming binder selected from the group consisting of epoxy resins, cyanate ester resins, thermoplastic polyurethanes, (meth)acrylic resins, and a combination thereof; (c) 20 to 40 weight percent of ammonium polyphosphate; and (d) 5 to 30 weight percent of melamine; wherein all weight percents are based on the total weight of the poly(2,6-dimethyl-1,4-phenylene ether), the film-forming binder, the ammonium polyphosphate, and the melamine

### Embodiment 14

The intumescent coating composition of embodiment 13, further comprising 1 to 20 weight percent, based on the total weight of the poly(2,6-dimethyl-1,4-phenylene ether), the film-forming binder, the ammonium polyphosphate, the melamine, and the carbon source, of a carbon source selected from the group consisting of pentaerythritol, dipentaerythritol, and a combination thereof.

### Embodiment 15

A coating film derived from the intumescent coating composition of any of embodiments 1-14, comprising: (a) a continuous phase comprising the film-forming binder or a cured product of the film-forming binder; and (b) a disperse phase comprising the particulate poly(phenylene ether), wherein the particulate poly(phenylene ether) has a mean particle size of 1 to 40 micrometers.

### Embodiment 16

A coated article comprising the coating film of embodiment 15 adhered to the article.

### Embodiment 17

The coated article of embodiment 16, wherein the coating film has a thickness of 0.25 to 10 millimeters.

### Embodiment 18

The coated article of embodiment 16, wherein the article is structural steel.

### Embodiment 19

A method of forming the intumescent coating composition of any of embodiments 1-10, comprising: mixing the particulate poly(phenylene ether), the film-forming binder, the acid source, the blowing agent, and optionally the carbon source other than the particulate poly(phenylene ether);

wherein the particulate poly(phenylene ether) has a glass transition temperature, and

wherein the mixing is carried out at a temperature below the glass transition temperature of the particulate poly(phenylene ether).

### Embodiment 20

A method of protecting an article against fire, comprising applying the intumescent coating composition of any of embodiments 1-14 to at least one surface of the article, and drying and/or curing the composition to form a coating film.

### EXAMPLES

Components used to prepare the compositions are described in Table 1.

TABLE 1

| Component | Description |
|---|---|
| PPE-A | Poly(2,6-dimethyl-1,4-phenylene ether), CAS Reg. No. 25134-01-4, |
| | having an intrinsic viscosity of 0.4 deciliter per gram measured in |
| | chloroform at 25° C.; obtained as PPO ™ 640 resin from SABIC Innovative |
| | Plastics, and having a mean particle size of 6.07 micrometers (PPE-A in |
| | Table 2). |
| PER | Pentaerythritol, CAS Reg. No. 115-77-5, available from Aldrich. |
| APP | Ammonium polyphosphate, CAS Reg. No. 68333-79-9, EXOLIT ™ AP |
| | 422, available from Clariant. |
| Melamine | Melamine, CAS Reg. No. 108-78-1, available from Aldrich. |
| EPON 828 | Diglycidyl ether of bisphenol A (“DGEBPA”), |
| | 2,2′-methylethylidenebis(4,1-phenyleneoxymethylene)]bisoxirane, CAS |
| | Reg. No. 001675-54-3, available from Momentive Specialty Chemicals. |
| MDA | Methylene dianiline |
| C85A | ELASTOLLAN ™ polyester-based TPU (Thermoplastic Urethane), |
| | available from BASF Corp. |
| C1185 | ELASTOLLAN ™ polyester-based TPU (Thermoplastic Urethane), |
| | available from BASF Corp. |
| MEK | Methyl ethyl ketone CAS Reg. No. 78-93-3, available from Fisher. |
| BADCy | 2,2-Bis(4-cyanophenyl)propane, CAS Reg. No. 1156-51-0, available from |
| | Lonza as PRIMASET ™ BADCy, |
| Al acac | Aluminum acetylacetonate, CAS Reg. No. 13963-57-0, available from |
| | Acros Organics. |
| PMMA | Poly(methyl methacrylate) powder, CAS Reg. No. 9011-14-7, M_{w}: |
| | 450,00-550,000, available from Alfa Aesar. |

Thermal gravimetric analysis (TGA) was conducted on a TA INSTRUMENTS THERMOGRAVIMETRIC ANALYZER™ from ambient temperature to 800° C. at a 20° C./minute temperature ramp. The analyses were conducted under nitrogen. All sample weights were in the range of 10.0±5 milligrams. The residual weight percentage was recorded at 600° C., 700° C., and 800° C.

### Preparative Example

### Jet Milling and Classification of Poly(Phenylene Ether)

Particulate poly(2,6-dimethyl-1,4-phenylene ether) was obtained by jet milling commercial grade poly(phenylene ether). Compressed nitrogen gas was introduced into nozzles of the jet mill to create a supersonic grinding stream. Commercial grade poly(2,6-dimethyl-1,4-phenylene ether) (PPO™ 640) in solid form, was injected into this violent, turbulent, rotating nitrogen stream. Particle-on-particle impact collisions in this grinding stream resulted in substantial particle size reductions. Large particles were held in the grinding area by centrifugal force while centripetal force drove finer particles towards the center of the discharge. A sieve of a specific upper size limit was then used to recover particles with a precise size distribution and having diameters below the nominal sieve openings. Larger particles were recycled to the reduction size chamber for further grinding. The particulate poly(2,6-dimethyl-1,4-phenylene ether) was classified by passing the jet-milled particles through a screen with 6, 14, or 20 micrometer openings. The resulting classified poly(2,6-dimethyl-1,4-phenylene ether) is designated PPE-A, PPE-B, and PPE-C, respectively, in Table 2. Particulate poly(2,6-dimethyl-1,4-phenylene ether) of larger particle size was obtained by sieving PPO™ 640 without jet milling. The poly(2,6-dimethyl-1,4-phenylene ether) was sized using U.S. Standard No. 200 (75 micrometer openings), No. 100 (150 micrometer openings), and No. 60 (250 micrometer openings). The resulting classified poly(2,6-dimethyl-1,4-phenylene ether) is designated PPE-D, PPE-E, and PPE-F, respectively, in Table 2.

Characterization of the poly(2,6-dimethyl-1,4-phenylene ether) particles is provided in Table 2. Particle size and shape distribution was determined using the CAMSIZER™ XT from Retsch Technology GmbH operating in air dispersion mode.

TABLE 2
Particle Size of Particulate Poly(2,6-dimethyl-1,4-phenylene ether)

| | | Mean | | | | | |
|---|---|---|---|---|---|---|---|
| | | particle | Stand. | D (v, 0.9)^{b} | D (v, 0.5)^{c} | D (v, 0.1)^{d} | Aspect |
| PPE | Method | size^{a} (μm) | Dev. | (μm) | (μm) | (μm) | Ratio |
| PPE-A | Milling | 6.07 | 2.3 | 8.1 | 5.9 | 4.0 | 0.709 |
| PPE-B | Milling | 10.9 | 4.7 | 17.0 | 10.4 | 5.5 | 0.724 |
| PPE-C | Milling | 15.7 | 5.9 | 23.3 | 15.2 | 8.6 | 0.855 |
| PPE-D | U.S. Stand. Sieve No. 200 | 46.7 | 25.3 | 79.2 | 46.6 | 11.2 | 0.755 |
| | (metric size 75 μm) | | | | | | |
| PPE-E | U.S. Stand. Sieve No. 100 | 87.8 | 54.1 | 160.8 | 87.3 | 16.7 | 0.749 |
| | (metric size 150 μm) | | | | | | |
| PPE-F | U.S. Stand. Sieve No. 60 | 264.1 | 97.6 | 377.7 | 275.2 | 122.6 | 0.747 |
| | (metric size 250 μm) | | | | | | |
| PPE-G | U.S. Stand. Sieve No. 40 | 538.8 | 197.9 | 769.6 | 541.5 | 369.5 | 0.759 |
| | (metric size 425 μm) | | | | | | |

^{a)}Mean particle size volume distribution.
^{b)}D(v,0.1) - 10% of the volume distribution is below this value.
^{c)}D(v,0.5) - 50% of the volume distribution is below this value.
^{d)}D(v,0.9) - 90% of the volume distribution is below this value.

The shape of the poly(2,6-dimethyl-1,4-phenylene ether) particles was examined by Scanning Electronic Microscopy (SEM). Samples were coated with gold and examined using a Carl Zeiss AG—EVO™ 40 Series scanning electron microscope. The conditions were SEM mode, a probe current of 40 picoamps, HV (high vacuum), and an acceleration voltage of 20 kilovolts.

There were a great variety of particle shapes, in the particulate poly(2,6-dimethyl-1,4-phenylene ether), which consisted partly of perturbed or irregularly shaped ellipsoidal and spheroidal particles, as viewed under 1,000× magnification by SEM.

Particle size and shape distribution of the particulate poly(2,6-dimethyl-1,4-phenylene ether) were determined using the CAMSIZER™ XT from Retsch Technology GmbH operating in air dispersion mode. The particle size is reported as a circular equivalent diameter. Where the 3-dimensional particle is imaged as 2-dimensional particle, the area of 2-dimensional image is converted to a circle with equal area, and the diameter of the circle measured. The aspect ratio is calculated by dividing the breath by the length of the 2-dimensional image.

Particle size measurements are calibrated using a certified NIST traceable highly precise (±0.1 micrometers) standard provided by Retsch Technology. The reference object is an electron beam lithographic pattern that simulates the entire measuring dynamic range of differently sized particles (1-3000 micrometers).

The validation of particle size was carried out using a NIST traceable DRI-CAL™ particle size secondary standard. The standard is comprised of polystyrene/divinylbenzene polymeric beads having a mean diameter of 23.2 micrometers±0.7 micrometers.

The poly(2,6-dimethyl-1,4-phenylene ether) designated “PPE-A” in Table 2, having a mean particle size of 6.07 micrometers, was used in the following examples.

### Example 1

### Epoxy Coating Compositions

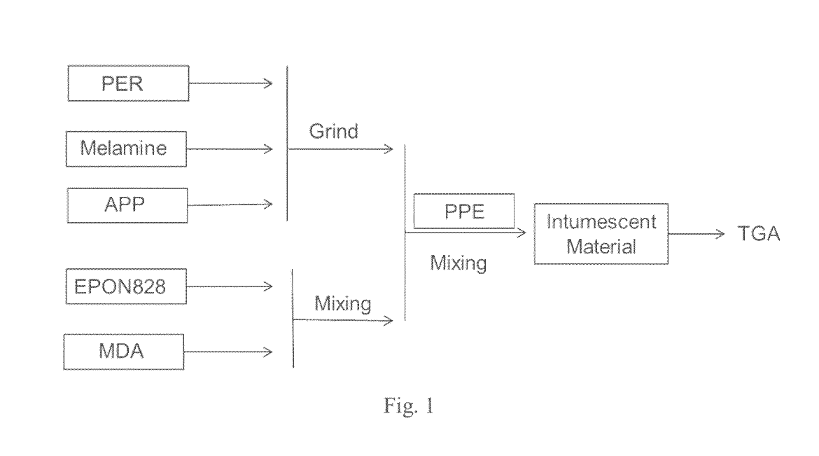

The epoxy coating compositions of Table 3 were prepared by the general procedure summarized in FIG. 1, using methods known to the skilled person in the art. As indicated in FIG. 1, PER, melamine, and APP, all solids, were ground together to a fine powder using an IKA™ A11 basic analytical mill, and the liquid components, EPON 828 and MDA, were mixed separately. The combined solid components and combined liquid components were mixed together, and PPE-A was added (Ex. 1a and 1b). The resulting compositions were mixed until homogeneous in appearance to form the intumescent coating compositions. TGA was conducted at 600, 700, and 800° C. under nitrogen. The TGA results are also provided in Table 3. The TGA data expressed as weight percent char is a measure of the efficacy of the compositions in generating char. As can be seen from these data, when particulate poly(2,6-dimethyl-1,4-phenylene ether) partially (Ex. 1a) or completely (Ex. 1b) replaces pentaerythritol as the carbon source, char formation is equal or better than the control with pentaerythritol alone as the carbon source (Comp. Ex. 1).

TABLE 3
Epoxy Coating Compositions

| | | |
|---|---|---|
| Comp. | Example | Example |
| Example 1 | 1a | 1b |

Compositions (Weight Percent)

| | | | |
|---|---|---|---|
| PER | 15 | 7.5 | 0 |
| PPE-A | 0 | 7.5 | 15 |
| Melamine | 15 | 15 | 15 |
| APP | 30 | 30 | 30 |
| EPON 828 | 35 | 35 | 35 |
| MDA | 5 | 5 | 5 |

Char Yields—Uncured (Weight Percent)

| | | | |
|---|---|---|---|
| Char in N₂ at 600° C. | 36.4 | 44.0 | 36.8 |
| Char in N₂ at 700° C. | 34.9 | 42.6 | 35.3 |
| Char in N₂ at 800° C. | 33.6 | 39.1 | 33.7 |

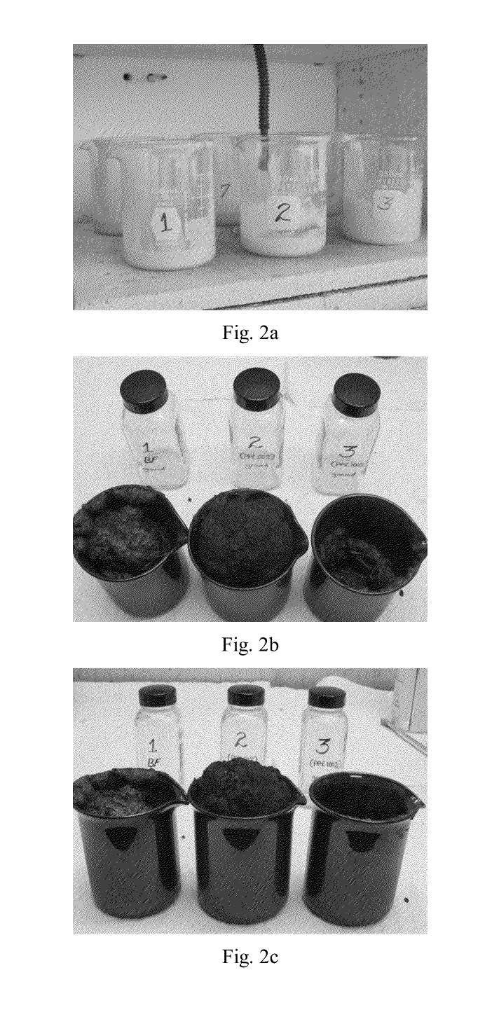

The epoxy coating compositions were also evaluated in a muffle furnace test. Samples of the compositions before curing were placed in 250-milliliter beakers and heated to 480-500° C. for 30 minutes in a muffle furnace. After cooling the oven to 300° C., the samples were removed from the oven. The resulting chars are depicted in FIG. 2, wherein “1” is Comp. Ex. 1, “2” is Ex. 1a, and “3” is Ex. 1b. FIG. 2a depicts the compositions before heating, and FIGS. 2b and 2c depict the compositions after heating. As can be seen from FIGS. 2b and 2c, Ex. 1a, containing both pentaerythritol and particulate poly(2,6-dimethyl-1,4-phenylene ether) as carbon sources, provided the highest vertical expansion of the coating composition.

### Examples 2 and 3

### Thermoplastic Polyurethane Coating Compositions

The thermoplastic polyurethane compositions of Table 4 were prepared as follows. PER, melamine, and APP were ground together to a fine powder. To this mixture was added binder (C85A or C1185), and then PPE-A. The resulting mixture was dispersed in the minimum amount of MEK to form intumescent coating compositions, which were coated onto aluminum dishes for TGA testing. The MEK was removed in a vacuum oven at 50° C. prior to testing. The results are provided in Table 4. As can be seen from these data, when particulate poly(2,6-dimethyl-1,4-phenylene ether) partially or completely replaces pentaerythritol as the carbon source (Ex. 2a and 2b), char formation can be equal or better than the control with pentaerythritol alone as the carbon source (Comp. Ex. 2).

TABLE 4
Thermoplastic Urethane Coating Compositions

| | | | | | |
|---|---|---|---|---|---|
| Comp. | Ex. | Ex. | Comp. | Ex. | Ex. |
| Ex. 2 | 2a | 2b | Ex. 3 | 3a | 3b |

Compositions (Weight Percent)

| | | | | | | |
|---|---|---|---|---|---|---|
| PER | 15 | 7.5 | 0 | 15 | 7.5 | 0 |
| PPE-A | 0 | 7.5 | 15 | 0 | 7.5 | 15 |
| Melamine | 15 | 15 | 15 | 15 | 15 | 15 |
| APP | 30 | 30 | 30 | 30 | 30 | 30 |
| C85A | 40 | 40 | 40 | 0 | 0 | 0 |
| C1185 | 0 | 0 | 0 | 40 | 40 | 40 |

Char Yields (Weight Percent)

| | | | | | | |
|---|---|---|---|---|---|---|
| Char in N₂ at | 19.83 | 24.08 | 24.51 | 28.78 | 30.13 | 24.88 |
| 600° C. | | | | | | |
| Char in N₂ at | 17.93 | 22.08 | 22.50 | 25.16 | 24.59 | 23.44 |
| 700° C. | | | | | | |
| Char in N₂ at | 16.39 | 20.49 | 21.06 | 22.81 | 22.83 | 22.18 |
| 800° C. | | | | | | |

### Example 4

### Cyanate Ester Coating Compositions

The cyanate ester compositions of Table 5 were prepared as follows. PER, melamine, and APP were ground together to a fine powder. To this mixture, was added BADCy and Al acac, and then PPE-A. The resulting mixture was dispersed in the minimum amount of MEK to form the intumescent coating composition, which was coated onto aluminum dishes for TGA testing. The MEK was removed in a vacuum oven at 50° C. prior to testing. Samples were either tested directly, or cured at 150° C. for one hour and at 200° C. for another hour, prior to testing. The results are provided in Table 5. As can be seen from these data, when particulate poly(2,6-dimethyl-1,4-phenylene ether) partially or completely replaces pentaerythritol as the carbon source (Ex. 4a and 4b), char formation can be comparable (uncured samples) or higher than (cured samples), the control with pentaerythritol alone as the carbon source (Comp. Ex. 4).

TABLE 5
Cyanate Ester Coating Compositions

| | | |
|---|---|---|
| Comp. | Example | Example |
| Example 4 | 4a | 4b |

Compositions (Weight Percent)

| | | | |
|---|---|---|---|
| PER | 15 | 7.5 | 0 |
| PPE-A | 0 | 7.5 | 15 |
| Melamine | 15 | 15 | 15 |
| APP | 30 | 30 | 30 |
| BADcy | 40 | 40 | 40 |
| Al acac | 0.05 | 0.05 | 0.05 |

Char Yields—Uncured (Weight Percent)

| | | | |
|---|---|---|---|
| Char in N₂ at 600° C. | 33.67 | 33.90 | 34.93 |
| Char in N₂ at 700° C. | 31.13 | 31.19 | 31.89 |
| Char in N₂ at 800° C. | 29.34 | 28.96 | 29.57 |

Char Yields—Cured at 150° C. and 200° C. (Weight Percent)

| | | | |
|---|---|---|---|
| Char in N₂ at 600° C. | 33.17 | 33.14 | 36.46 |
| Char in N₂ at 700° C. | 30.47 | 31.68 | 33.68 |
| Char in N₂ at 800° C. | 28.86 | 30.57 | 30.75 |

### Example 5

### Polyacrylate Coating Compositions

The thermoplastic polyacrylate compositions of Table 6 were prepared as follows. PER, melamine, and APP were ground together to a fine powder. To this mixture was added the PMMA, and then PPE-A. The resulting mixture was dispersed in the minimum amount of MEK to form the intumescent coating composition, and coated onto aluminum dishes for TGA testing. The MEK was removed in a vacuum oven at 50° C. prior to testing. The results are provided in Table 6. As can be seen from these data, when particulate poly(2,6-dimethyl-1,4-phenylene ether) partially or completely replaces pentaerythritol as the carbon source (Ex. 5a and 5b), char formation is higher than the control with pentaerythritol alone as the carbon source (Comp. Ex. 5).

TABLE 6
Acrylate Coating Compositions

| | | |
|---|---|---|
| Comp. | Example | Example |
| Example 5 | 5a | 5b |

Compositions (Weight Percent)

| | | | |
|---|---|---|---|
| PER | 7.5 | 3.75 | 0 |
| PPE-A | 0 | 3.75 | 7.5 |
| Melamine | 7.5 | 7.5 | 7.5 |
| APP | 15 | 15 | 15 |
| PMMA | 20 | 20 | 20 |

Char Yields (Weight Percent)

| | | | |
|---|---|---|---|
| Char in N₂ at 600° C. | 20.59 | 24.40 | 25.39 |
| Char in N₂ at 700° C. | 16.72 | 22.04 | 24.01 |
| Char in N₂ at 800° C. | 14.18 | 20.31 | 22.83 |

1. An intumescent coating composition comprising:
(a) particulate poly(phenylene ether), wherein the mean particle size of the poly(phenylene ether) is 1 to 100 micrometers;
(b) a film-forming binder;
(c) an acid source;
(d) a blowing agent; and
(e) optionally, a carbon source other than the particulate poly(phenylene ether);
wherein polyolefins, homopolystyrenes, rubber-modified polystyrenes, styrene-containing copolymers, and hydrogenated and unhydrogenated block copolymers of an alkenyl aromatic compound and a conjugated diene are all absent from the composition.

2. The intumescent coating composition of claim 1, wherein the carbon source is present, and is selected from the group consisting of mannitol, sorbitol, dulcitol, inositol, arabitol, pentaerythritol, dipenterythritol, tripentaerythritol, sucrose, glucose, dextrose, starch, dextrins, polyvinyl alcohols, melamine-formaldehyde resins, urea-formaldehyde resins, ethyleneurea-formaldehyde resins, chlorinated paraffin waxes, expandable graphite, and a combination thereof.

3. The intumescent coating composition of claim 1, comprising:
(a) 1 to 40 weight percent of the poly(phenylene ether);
(b) 50 to 90 weight percent of the film-forming binder;
(c) 4 to 60 weight percent of the acid source;
(d) 1 to 30 weight percent of the blowing agent; and
(e) 0 to 40 weight percent of the carbon source other than the particulate poly(phenylene ether);
wherein all weight percents are based on the total weight of the poly(phenylene ether), the film-forming binder, the acid source, the blowing agent, and the carbon source other than the particulate poly(phenylene ether).

4. The intumescent coating composition of claim 3, wherein the poly(phenylene ether) is poly(2,6-dimethyl-1,4-phenylene ether).

5. The intumescent coating composition of claim 3, wherein the film-forming binder does not comprise poly(phenylene ether).

6. The intumescent coating composition of claim 3, wherein the film-forming binder is selected from the group consisting of (meth)acrylic resins, poly(vinyl acetate), vinyl acetate-(meth)acrylic copolymers, ethylene-vinyl acetate copolymers, ethylene-vinyl acetate-vinyl chloride terpolymers, polyurethanes, polyesters, polyamides, cellulosic resins, polyvinyl chloride, polyvinylidene chloride, fluoropolymers, epoxy resins, unsaturated polyesters, alkyds, amino resins, melamine-formaldehyde resins, urea-formaldehyde resins, phenol-formaldehyde resins, silicone resins, cyanate esters, curable ethylenically unsaturated monomers, thermoplastic polyurethanes, thermoplastic polyamides, thermoplastic copolyetheresters, chlorinated rubbers, and a combination thereof.

7. The intumescent coating composition of claim 3, wherein the mean particle size of the poly(phenylene ether) is 1 to 40 micrometers.

8. The intumescent coating composition of claim 3, wherein 90 percent of the particle volume distribution of the poly(phenylene ether) is less than 8 micrometers.

9. The intumescent coating composition of claim 3, wherein the acid source is selected from the group consisting of monoammonium phosphate, diammonium phosphate, monosodium phosphate, disodium phosphate, monopotassium phosphate, dipotassium phosphate, ammonium polyphosphate, metaphosphoric acid, orthophosphoric acid, pyrophosphoric acid, hypophosphorous acid, melamine phosphate, melamine pyrophosphate, melamine polyphosphate, melamine pentaerythritol diphosphate, ammonium sulfate, ammonium chloride, boric acid, and a combination thereof.

10. The intumescent coating composition of claim 3, wherein the blowing agent is selected from the group consisting of melamine, melamine polyphosphate, melamine cyanurate, melamine isocyanurate, tris(hydroxyethyl) isocyanurate, dicyandiamide, urea, dimethylurea, guanidine, cyanoguanidine, glycine, chlorinated paraffin wax, alumina trihydrate, magnesium hydroxide, zinc borate hydrate, and a combination thereof.

11. The intumescent coating composition of claim 3, further comprising 0.1 to 50 weight percent, based on the dry weight of the composition, of a flame retardant selected from the group consisting of brominated organic compounds and polymers, phosphate esters, chloroalkyl phosphate esters, phosphonate esters, phosphinate esters, expandable graphite, metal oxides, hydrated metal oxides, ammonium salts, silicates, and a combination thereof.

12. The intumescent coating composition of claim 3, further comprising 0.1 to 50 weight percent, based on the dry weight of the composition, of a filler selected from the group consisting of calcium carbonate, baryte, gypsum, silica, diatomaceous earth, alumina, calcium silicate, perlite, wollastonite, talc, mica, feldspar, nepheline syenite, kaolinite, bentonite, montmorillonite, attapulgite, pyrophyllite, glass fiber, carbon fiber, organic polymer fibers, and a combination thereof.

13. The intumescent composition of claim 1, comprising:
(a) 10 to 40 weight percent of poly(2,6-dimethyl-1,4-phenylene ether) having a mean particle size of 1 to 10 micrometers;
(b) 30 to 50 weight percent of a film-forming binder selected from the group consisting of epoxy resins, cyanate ester resins, thermoplastic polyurethanes, (meth)acrylic resins, and a combination thereof;
(c) 20 to 40 weight percent of ammonium polyphosphate; and
(d) 5 to 30 weight percent of melamine,
wherein all weight percents are based on the total weight of the poly(2,6-dimethyl-1,4-phenylene ether), the film-forming binder, the ammonium polyphosphate, and the melamine.

14. The intumescent coating composition of claim 13, further comprising 1 to 20 weight percent, based on the total weight of the poly(2,6-dimethyl-1,4-phenylene ether), the film-forming binder, the ammonium polyphosphate, the melamine, and the carbon source, of a carbon source selected from the group consisting of pentaerythritol, dipentaerythritol, and a combination thereof.

15. A coating film derived from the intumescent coating composition of claim 1, comprising:
(a) a continuous phase comprising the film-forming binder or a cured product of the film-forming binder; and
(b) a disperse phase comprising the particulate poly(phenylene ether), wherein the particulate poly(phenylene ether) has a mean particle size of 1 to 40 micrometers.

16. A coated article comprising the coating film of claim 15 adhered to the article.

17. The coated article of claim 16, wherein the coating film has a thickness of 0.25 to 10 millimeters.

18. The coated article of claim 16, wherein the article is structural steel.

19. A method of forming the intumescent coating composition of claim 1, comprising: mixing the particulate poly(phenylene ether), the film-forming binder, the acid source, the blowing agent, and optionally the carbon source other than the particulate poly(phenylene ether);
wherein the particulate poly(phenylene ether) has a glass transition temperature, and
wherein the mixing is carried out at a temperature below the glass transition temperature of the particulate poly(phenylene ether).

20. A method of protecting an article against fire, comprising applying the intumescent coating composition of claim 1 to at least one surface of the article, and drying and/or curing the composition to form a coating film.
